(19) United States
(12) Patent Application Publication
(10) Pub. No.: US 2018/0324116 A1
(43) Pub. Date: Nov. 8, 2018

(54) METHOD AND SYSTEM FOR ORGANIZING CHAT CONTENT

(71) Applicant: Alexandru George VADUVA, San Jose, CA (US)

(72) Inventor: Alexandru George VADUVA, San Jose, CA (US)

(21) Appl. No.: 15/785,124

(22) Filed: Oct. 16, 2017

Related U.S. Application Data
(60) Provisional application No. 62/503,240, filed on May 8, 2017.

(51) Int. Cl. H04L 12/58; G06F 3/0484; G06F 3/0482

(52) U.S. Cl. CPC H04L 51/04; H04L 51/16; G06F 3/04883; G06F 3/0482; G06F 3/04842

(57) ABSTRACT

A method and system for organizing content associated with chat conversations are disclosed. The method includes causing display of a first chat window on a display screen of an electronic device of a user for facilitating a chat conversation between the user and at least one other user. An input related to the first chat window is received from the user during the course of the chat conversation. The input is indicative of the user's requirement of discussing a new topic within the chat conversation. Display of a second chat window is caused on the display screen in response to the reception of the input to facilitate the discussion corresponding to the new topic.

### TECHNICAL FIELD

The present technology generally relates to user messaging applications, and more particularly, to a method and system for organizing chat content associated with chat conversations.

### BACKGROUND

Nowadays, given the ubiquity of high-speed data networks and proliferation of electronic devices capable of connecting to the high-speed data networks, users are easily and frequently connecting with each other. For example, users are increasingly connecting with each other using instant messaging applications, such as chat applications. Individuals may chat with each other to discuss a variety of topics. Typically, in a single chat conversation between two users there may be several topics discussed ranging from small talk discussions to important topics. For example, users may discuss a recent sports game or the latest episode of a favorite TV show to relatively important topics like holiday plans, grocery list, new products to be purchased, etc.

Generally, when a user wants to retrieve a particular piece of information from a chat conversation, the user has to open the chat history and search for the desired information in the chat history. It may happen that a lot of conversation may have occurred since the topic of choice was discussed, or in some cases, the desired topic may have been discussed over several days and, as such, may be available in a scattered form in the chat history. The user may have to manually sift through the chat history by scrolling and identifying items of interest to retrieve the desired information, which may be cumbersome for the user and may reduce the productivity of a user. In some example scenarios, as several topics are generally discussed during a chat conversation, a chat participant may forget to respond to a topic on account of high chat activity with the other chat participant.

Accordingly, there is a need to organize chat content to enable quick access to the right information in a chat conversation while precluding manual effort on part of the chat participant. Moreover, there is a need to enable the user to keep track of topics being discussed and not fail to respond to a topic on account of high chat activity.

### SUMMARY

Various embodiments of the invention provide methods and systems for organizing content associated with chat conversations.

In an embodiment, a computer-implemented method for facilitating organization of content associated with chat conversations is disclosed. The method includes causing display of a first chat window on a display screen of an electronic device of a user for facilitating a chat conversation between the user and at least one other user. The method includes receiving input related to the first chat window from the user during the course of the chat conversation. The input is indicative of the user's requirement of discussing a new topic within the chat conversation. The method includes causing display of a second chat window on the display screen in response to the reception of the input to facilitate the discussion corresponding to the new topic.

In an embodiment, a system for facilitating organization of content associated with chat conversations is disclosed. The system includes at least one processor and a memory. The memory includes stored therein machine executable instructions, that when executed by the at least one processor, cause the system to cause display of a first chat window on a display screen of an electronic device of a user for facilitating a chat conversation between the user and at least one other user. The system receives input related to the first chat window from the user during the course of the chat conversation. The input is indicative of the user's requirement of discussing a new topic within the chat conversation. The system causes display of a second chat window on the display screen in response to the reception of the input to facilitate the discussion corresponding to the new topic.

In an embodiment, another computer-implemented method for facilitating organization of content associated with chat conversations is disclosed. The method includes causing display of a first chat window on a display screen of an electronic device of a user for facilitating a chat conversation between the user and at least one other user. The method includes analyzing chat messages exchanged between the user and the at least one other user during the course of the chat conversation. The chat messages are analyzed to detect initiation of one or more new topics. Subsequent to detection of initiation of each new topic, the method includes performing: (1) providing a suggestion to the user to continue discussion corresponding to a new topic in a new window; (2) receiving user input indicative of the user's confirmation for continuing the discussion corresponding to the new topic in the new window; and (3) causing display of the new window on the display screen in response to the reception of the user input to facilitate the discussion corresponding to the new topic in the new window.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 shows an example representation of an environment in which various embodiments of the present invention may be practiced;

FIG. 2 is a block diagram of a system of FIG. 1 configured to facilitate organization of content associated with chat conversations, in accordance with an example embodiment of the invention;

FIG. 3 shows a simplified representation of a first chat window displayed to a user, in accordance with an example embodiment of the invention;

FIG. 4A shows an example representation illustrating creation of a new chat thread for initiating a new topic in a chat conversation, in accordance with an example embodiment of the invention;

FIG. 4B shows a second chat window displayed to a user in response to the user input indicative of a start of a new topic, in accordance with an example embodiment of the invention;

FIG. 5 shows an example representation illustrating multiple chat windows corresponding to multiple topics discussed by the chat participants during the course of a chat conversation, in accordance with an example embodiment of the invention;

FIG. 6A shows a simplified representation for illustrating a provisioning of a suggestion to a user for discussing a new topic in a new window, in accordance with an example embodiment of the invention;

FIG. 6B shows a simplified representation for illustrating display of a new chat window for facilitating discussion of the new topic in the new chat window, in accordance with an example embodiment of the invention;

FIGS. 7A and 7B show simplified representations of a first chat window and a second chat window displayed to a user for illustrating movement of messages from the first chat window to the second chat window, in accordance with an example embodiment of the invention;

FIG. 8A shows a simplified representation of a first chat window including an example chat conversation displayed to a user, in accordance with an example embodiment of the invention;

FIG. 8B shows a simplified representation of a second chat window including the selected messages, in accordance with an example embodiment of the invention;

FIG. 9 shows an example representation illustrating the plurality of chat windows in a collapsed form, in accordance with an example embodiment of the invention;

FIG. 10 is a flow diagram of a method for facilitating organization of content associated with a chat conversation, in accordance with an example embodiment of the invention;

FIG. 11 is a flow diagram of a method for facilitating organization of content associated with a chat conversation, in accordance with another example embodiment of the invention; and

FIG. 12 illustrates an electronic device capable of implementing the various embodiments of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the invention. Similarly, although many of the features of the invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The present invention discloses methods and systems for organizing content associated with chat conversations. Generally, a variety of topics are discussed during the course of a single chat conversation between two or more chat participants. If a particular piece of information is to be retrieved from the chat conversation at a later point in time, then the user has to manually sift through the chat history by scrolling through the content and identifying items of interest. Various embodiments disclosed herein facilitate organization of chat content that enables users to quickly access the desired information from the chat content. More specifically, the various embodiments disclosed herein suggest opening a new chat window for each new topic or subject being discussed during the course of the chat conversation. A user may provide an indication that a new topic is being initiated. In some embodiments, the initiation of the new topic within the chat conversation may be detected based on analysis of chat messages and a suggestion to discuss the new topic in a new chat window may be provisioned to the user. The user may provide an input providing a confirmation for discussing the new topic in a new window. Accordingly, a new chat window may be opened in response to such an input. Similarly, a new chat window may be opened for each new subject to be introduced within the chat conversation. As individual subjects or topics within the chat conversation are discussed within separate chat windows, a chat participant may easily retrieve desired information. Moreover, the chat participant may never fail to respond to any topic on account of high chat activity, as the topics are not mixed with each other as in conventional chats.

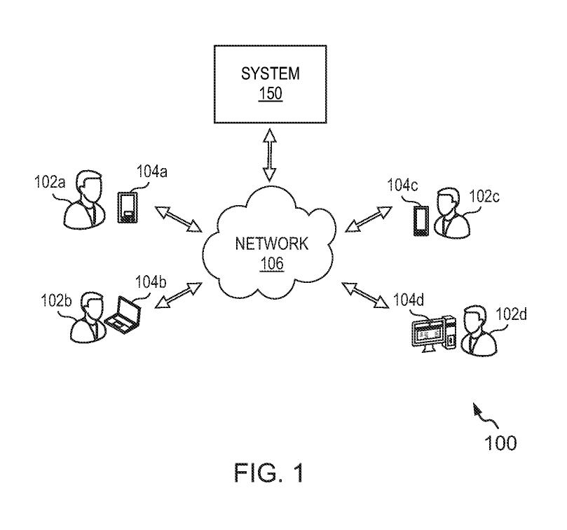

FIG. 1 shows an example representation of an environment 100 in which various embodiments of the present invention may be practiced. The environment 100 is depicted to include a plurality of users, such as users 102a, 102b, 102c and 102d. It is noted that the environment 100 is depicted to include four users for illustration purposes and that the environment 100 may include fewer or more users than those depicted in FIG. 1. Each user is associated with an electronic device capable of connecting to a communication network, such as a network 106. For example, the user 102a is depicted to be associated with an electronic device 104a; the user 102b is depicted to be associated with an electronic device 104b; the user 102c is depicted to be associated with an electronic device 104c; and the user 102d is depicted to be associated with an electronic device 104d. Some examples of the electronic devices 104a-d may include laptops, smartphones, desktops, tablets, wearable devices, workstation terminals, and the like. The network 106 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or Zigbee networks, and the like. An example of a combination of wired and wireless networks may include the Internet or a Cloud-based network.

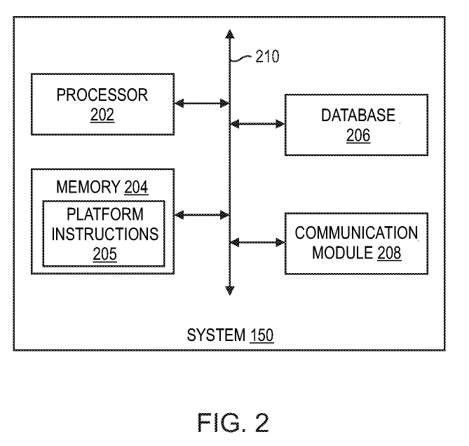

The environment 100 is further depicted to include a system 150. The system 150 is configured to facilitate organization of content associated with chat conversations as will be explained with reference to FIGS. 2-8. In an embodiment, the system 150 is capable of providing a chat application program for facilitating chat conversations between two or more users, such as users 102a-d. The chat application program, when accessed, is configured to display a first chat window on a display screen of a user's respective electronic device. The chat application program is further configured to receive an input from the user, which is indicative of the user's interest in discussing a new chat topic. In some embodiments, the input may be provided in response to a suggestion provided by the chat application to continue discussion of a new topic in a new chat window (also interchangeably referred to herein as new window). Upon receiving such an input, the chat application program is configured to cause display of a second chat window to enable the user to discuss the new topic in a new chat window. The user may also be provided with an option to assign a name or title to the new topic. Accordingly, the user may initiate several new topic threads in separate chat windows. When the user accesses the chat conversation with the same user at a later point in time, the various chat windows may be displayed within a single chat window in a cascaded form and the user may choose any window to view the chat history related to the topic discussed in that chat window. Such organization of chat content enables the user to quickly retrieve the desired information from the chat content. Moreover, the user may never fail to respond to any topic on account of high chat activity, as the topics are not mixed with each other as in conventional chats. The various components of the system 150 are explained next with reference to FIG. 2.

FIG. 2 is a block diagram of the system 150 of FIG. 1 configured to facilitate organization of content associated with chat conversations, in accordance with an example embodiment of the invention. The content associated with chat conversations is also referred to as ‘chat content’ hereinafter.

In one embodiment, the system 150 is embodied as chat platform capable of being accessed by user electronic devices via a communication network, such as the network 106 (shown in FIG. 1). The chat platform may be implemented as a set of software layers on top of existing hardware systems. For example, the chat platform may be implemented as a standalone component in a remote machine, such as cloud based server or a Web server, connected to the communication network and capable of executing a set of instructions (sequential and/or otherwise) to facilitate chat conversations between a plurality of users.

In some embodiments, the chat platform may be configured to provision chat application services as a Web service accessible through a Website. In such a scenario, the users may access the Website over the network 106 using Web browser applications installed in their respective electronic devices and thereafter chat with other participants, who have accessed the chat platform in a similar manner. More specifically, a user may launch a Web browser application installed in an electronic device associated with the user and thereafter access the system 150 using a uniform resource locator (URL) associated with the system 150. Alternatively, the system 150 may be configured to provide a thin client interface or an instance of an application capable of being downloaded on the electronic device of the user. The user may then launch the application to connect to the system 150 over the network 106 and access the system 150. In at least some example embodiments, the user may register with the chat platform upon first-time access and thereafter use a login ID and password to access the system 150. The user registration and subsequent login may be performed using well-known techniques for user registration and access to software platforms and are not explained herein.

In one embodiment, one or more functionalities of the chat platform may also be embodied as a client (i. e. a computer program) within devices, such as electronic devices of chat participants (also referred to herein as users). For example, the system 150 is configured to provision a chat application program to users, such as the users 102a-102d, for facilitating chat conversations amongst them. The users may request the system 150 to provision access to the chat application over the network 106. The chat application program may thereafter be downloaded on the electronic devices of the respective users in response to their request for access to the chat application. Alternatively, in some embodiments, the chat application may be factory installed within the electronic devices associated with the users 102a-102d and, as such, the users may not need to explicitly request the chat application from the system 150.

The system 150 is depicted to include at least one processor such as the processor 202, a memory 204, a database 206, and a communication module 208. In an embodiment, the memory 204 is capable of storing machine executable instructions, referred to herein as platform instructions 205. Further, the processor 202 is capable of executing the platform instructions 205. In an embodiment, various components of the system 150, such as the processor 202, the memory 204, the database 206 and the communication module 208 are configured to communicate with each other via or through a centralized circuit system 210. The centralized circuit system 210 may be various devices configured to, among other things, provide or enable communication between the components (202-208) of the system 150. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.).

In an embodiment, the database 206 may be implemented as a relational database, a centralized database, a distributed database, an object oriented database, or a flat database. The database 206 is configured to store content related to chat conversations conducted using the chat application services/program provided by the system 150. The content may be tagged with names of participants, date/time metadata, and the like to facilitate ease of retrieval of the chat conversations. In some embodiments, the centralized circuit system 210 may include appropriate storage interfaces to facilitate communication between the processor 202 and the database 206. Some examples of the storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the information stored in the database 206.

In at least one embodiment, the communication module 208 includes communication circuitry such as for example, a transceiver circuitry including antenna and other communication media interfaces to connect to wired and/or wireless networks (such as for example, the network 106 shown in FIG. 1). The communication circuitry may, in at least some example embodiments, enable transmission of data signals and/or reception of signals from remote network entities, such as electronic devices of users.

It is noted that the system 150 as illustrated and hereinafter described is merely illustrative of an apparatus that could benefit from embodiments of the invention and, therefore, should not be taken to limit the scope of the invention. It is noted that the system 150 may include fewer or more components than those depicted in FIG. 2.

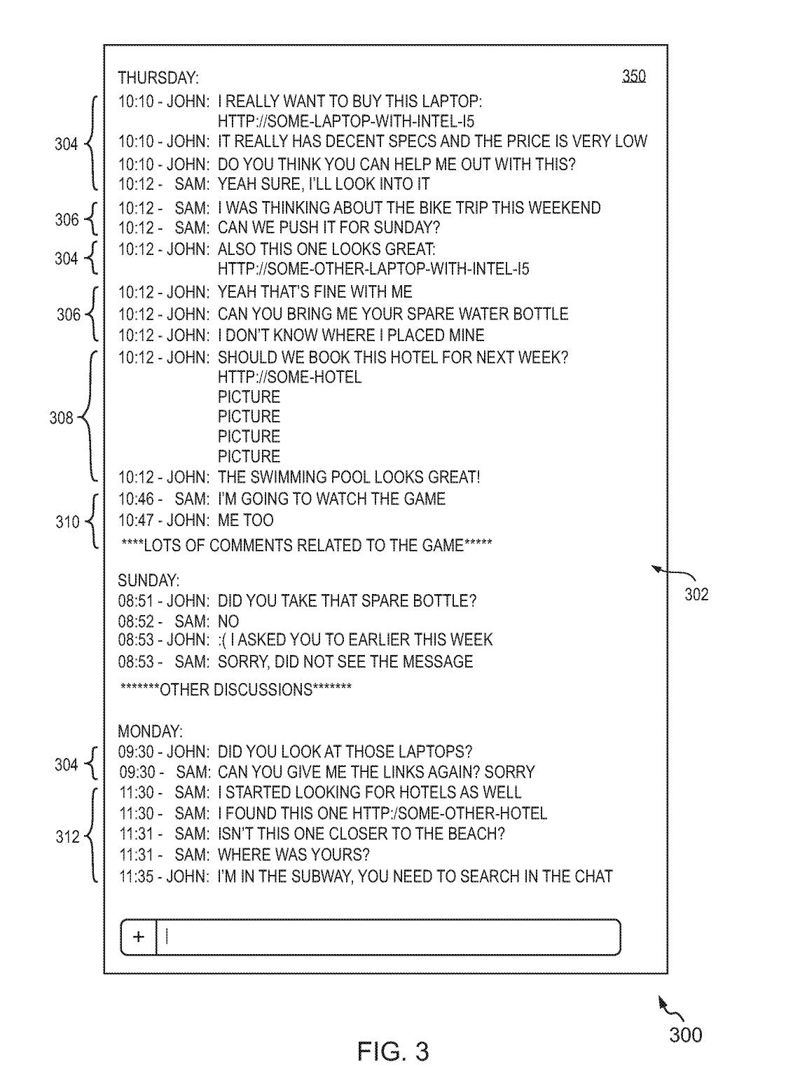

In at least one example embodiment, the system 150 may be configured to cause display of a first chat window on a display screen of an electronic device of a user for facilitating a chat conversation between the user and at least one other user. For example in FIG. 1, the user 102a may wish to chat with the user 102d and accordingly, the user 102a may access the system 150 over the network 106 using the electronic device 104a. As explained above, a user may register with the system 150 to use the chat application services provided by the system 150. In some cases, the system 150 may also provision a chat application program to the user 102a upon successful registration. Upon subsequent access of the system 150, a first chat window may be displayed on the display screen of the electronic device 104a. The user 102a may input a chat message intended for recipient 102d in the first chat window. A similar chat window may also be displayed on the electronic device 104d of the user 102d, who may also have registered with the system 150 for utilizing chat application services provided by the system 150. The chat window displayed on the electronic device 104d associated with the user 102d may include the chat message provided by the user 102a. The user 102d may respond to the chat message thereby initiating a chat conversation between the two users. In some embodiments, the chat conversation may involve more than two participants. An example first chat window displayed to the user on the display screen of the user's electronic device is shown in FIG. 3.

Referring now to FIG. 3, a simplified representation of a first chat window 300 displayed to a user is shown, in accordance with an example embodiment of the invention. As explained with reference to FIG. 2, the system 150 may cause display of a first chat window on a display screen of a user's electronic device to facilitate chat conversation between the user and at least one other user. An example first chat window 300 displayed to chat participants on their respective electronic devices is shown in FIG. 3.

The first chat window 300 shows a UI 350 including an example chat conversation 302 between two users: ‘John’ and ‘Sam’. Accordingly, the first chat window 300 may be displayed on display screens of the electronic devices associated with John and Sam (the display screens are not shown in FIG. 3). Further, as can be seen from the chat conversation 302, several topics are discussed during the course of a single chat conversation. For example, portions 304 of the chat conversation 302 correspond to a topic related to a purchase of a new laptop. Similarly, portions 306, 308 and 310 of the chat conversation 302 correspond to topics related to a bike trip, a summer plan and a basketball game, respectively. Furthermore, the chat conversation 302 is depicted to have been conducted over multiple days. In the event of a chat participant wishing to retrieve a particular piece of information, the chat participant may have to go through the entire chat history and sift through multiple topics to identify the item of interest. Such a scenario is exemplarily depicted in FIG. 3. At portion 312 of the chat conversation 302, the chat participant Sam wants to know the location of the hotel suggested by John and, in turn, is requested by John to search through the chat history to get the link of the hotel he had previously suggested. To preclude manual searching of content, the system 150 as proposed herein is configured to enable the user to open a new chat thread in a new chat window for each new topic to be discussed, so as to enable each user to quickly obtain the desired information at a later point in time.

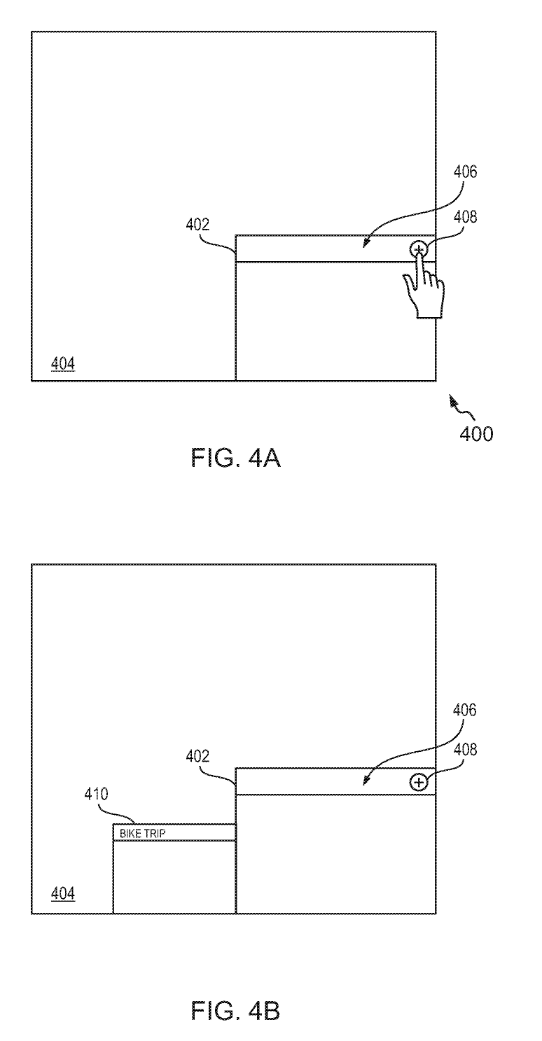

Referring now to FIG. 2, in at least one example embodiment, the first chat window (such as the first chat window 300 shown in FIG. 3) displayed to the user is configured to display one of a button, a tab and a widget. The user selection of the button, the tab or the widget is configured to indicate the user's desire to initiate a new topic. The user may select the button, tab or widget any time during the course of the chat conversation with the other user to indicate his or her requirement of initiating a new topic. In at least one example embodiment, the communication module 208 of the system 150 is configured to receive an input related to the first chat window, or more specifically, receive a selection of the button/tab/widget on the first chat window and provision the input to the processor 202. The processor 202 may be configured to cause display of a second chat window on the display screen of the user's electronic device in response to the reception of the selection input. The display of the second chat window may be caused to enable the user to discuss the new topic in a new window. The input related to the first chat window may not be limited to the selection of the button, tab or widget. In some embodiments, the user may provide a predefined gesture, such as a swipe input or touch input on the header portion of the first chat window to indicate his or her requirement of initiating a new topic. The provisioning of the user input and the display of the second chat window is exemplarily depicted in FIGS. 4A and 4B.

Referring now to FIG. 4A, an example representation 400 illustrating creation of a new chat thread for initiating a new topic in a chat conversation is shown, in accordance with an example embodiment of the invention. More specifically, FIG. 4A depicts a first chat window 402 located in a right-hand bottom corner of a display screen 404. The first chat window 402 may be configured to display a UI such as the UI 350 explained with reference to FIG. 3. The first chat window 402 is further depicted to include a header portion 406. The header portion 406 is depicted to include a button 408 capable of receiving user input, such as a selection input. A user may provide a touch or a click input on the button 408 to provision the user selection. In at least one example embodiment, subsequent to reception of such a user input, the system 150 may be caused to display a second chat window, substantially adjacent to the first chat window 402 as exemplarily depicted in FIG. 4B. More specifically, FIG. 4B shows a second chat window 410 displayed to the user in response to the user input indicative of a start of a new topic, in accordance with an embodiment of the invention. More specifically, the second chat window 410 is displayed to the user in response to the user selection of the button 408, which is indicative of the user's requirement to start a new topic. In at least one example embodiment, the user may be provided with an option to provide a title or a name to the newly opened chat window 410. For example, if the user wants to initiate a new topic related to a bike trip, then the user may provide a textual input ‘BIKE TRIP’ as a title for the newly created chat window, i.e. the second chat window 410. The second chat window 410 may then be caused to display the title in the header portion as exemplarily depicted in FIG. 4B. It is noted that such creation of a new chat window may not be limited to only one thread and that multiple threads may be discussed in multiple new chat windows created as explained herein. It is further noted that the creation of a new thread/window may not be limited to user selection of buttons, such as the button 408. In at least some embodiments, the system 150 may be configured to receive a predefined gesture such as a swipe input on the header portion or even a touch input on the header portion to indicate the desire to open a new thread in a new window. The system 150 may be configured to recognize such an input and display another window, such as the second chat window 410 displayed in FIG. 4B.

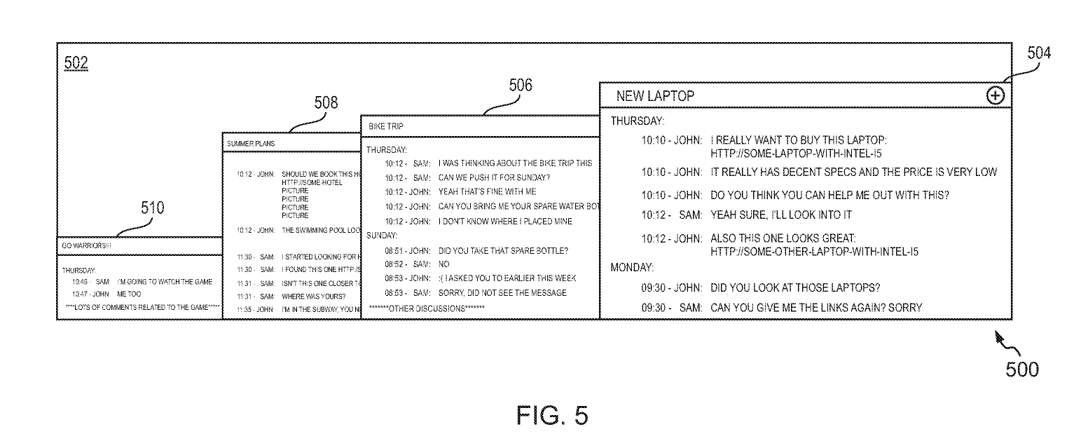

Referring now to FIG. 2, the system 150 may be configured to cause display of one or more additional chat windows subsequent to the display of the second chat window to enable the chat participants engaged in a chat conversation to initiate new threads in new chat windows. The display of each additional chat window may be caused in response to the reception of a corresponding input related to the first chat window from the user. More specifically, for each new subject or topic to be discussed, the user may provide a selection input on the button, such as the button 408 shown in FIG. 4A, or provide a predefined gesture input to indicate the desire to start a new topic. In some embodiments, each new window may include a button, such as the button 408, and the user may cause invoking of an additional window by providing a selection input on a button on the current chat window. The system 150 may be configured to interpret such an input and cause display of a new chat window each time the user provides the button input or the gesture input. Furthermore, in at least some embodiments, the user may provide a title for each chat window such that each additional chat window is associated with a respective title provided by the user as an identification of a corresponding topic. Such a scenario is depicted in FIG. 5.

FIG. 5 shows an example representation 500 illustrating multiple chat windows corresponding to multiple topics discussed by the chat participants during the course of the chat conversation, in accordance with an example embodiment of the invention. As explained with reference to FIGS. 4A and 4B, a chat participant (also interchangeably referred to herein as a user) may provide a user selection indicating his/her desire to initiate a new topic. Subsequent to receiving such an input, a new chat window may be displayed to the user, and the user may discuss the new topic in the new chat window. Several topics may similarly be discussed in separate chat windows as exemplarily depicted in FIG. 5. More specifically, the example representation 500 depicts a display screen 502 of an electronic device showing multiple chat windows, such as chat window 504, chat window 506, chat window 508 and chat window 510. Each chat window includes content related to a specific topic as indicated by the header of the chat window. For example, the chat window 504 includes content related to a discussion between John and Sam for purchase of a laptop. The header of the chat window 504 is depicted to display a title ‘NEW LAPTOP’. As explained with reference to FIGS. 4A and 4B, a user may provide a title or name to the chat window subsequent to the display of the chat window for initiating the new topic. In the illustrative example, John may provide the title ‘NEW LAPTOP’ for initiating a discussion related to the purchase of a new laptop with Sam. Similarly, the chat windows 506, 508 and 510 are depicted to include content related to a bike trip related discussion, summer plans and a basketball game related discussion, respectively. As can be seen, the chat windows 506, 508 and 510 are associated with titles ‘BIKE TRIP’, ‘SUMMER PLANS’ and ‘GO WARRIORS!!!’ indicative of the topic being discussed in the corresponding chat windows.

Though FIGS. 2 to 5 explain user initiated opening of a new chat window for discussing a new topic, in some embodiments, the initiation of a new topic in a chat conversation may be detected by analyzing chat messages in an ongoing manner and the user may be prompted to continue discussion of a new topic in a new chat window subsequent to detection of initiation of a new topic within the chat conversation. To that effect, the system 150 of FIG. 2 may be configured to perform analysis of chat messages in substantially real-time. Various machine learning algorithms for learning context may be stored in the memory 204 of the system 150. These algorithms may be configured to learn a current context of the chat conversation based on analysis of the current chat line, one or more succeeding chat lines and one or more preceding chat lines. For example, based on recognition of words like ‘Laptop’ and ‘Buy’ in a chat line shown in portion 304 of FIG. 3, a context related to buying a laptop may be learnt by a machine learning algorithm. Further, words like ‘bike’ and ‘trip’ in subsequent chat lines (such as chat lines in portion 306 of FIG. 3) may be recognized and a distance measure corresponding to the words ‘laptop’ and ‘buy’ in previous chat lines may be computed. If the distance measure is beyond a predefined threshold value (such as for example, above five on a scale of one to ten), then a change in context may be detected. Such a detected change in context may suggest initiation of a new topic, or in other words, an initiation of a new topic within a chat conversation may be detected.

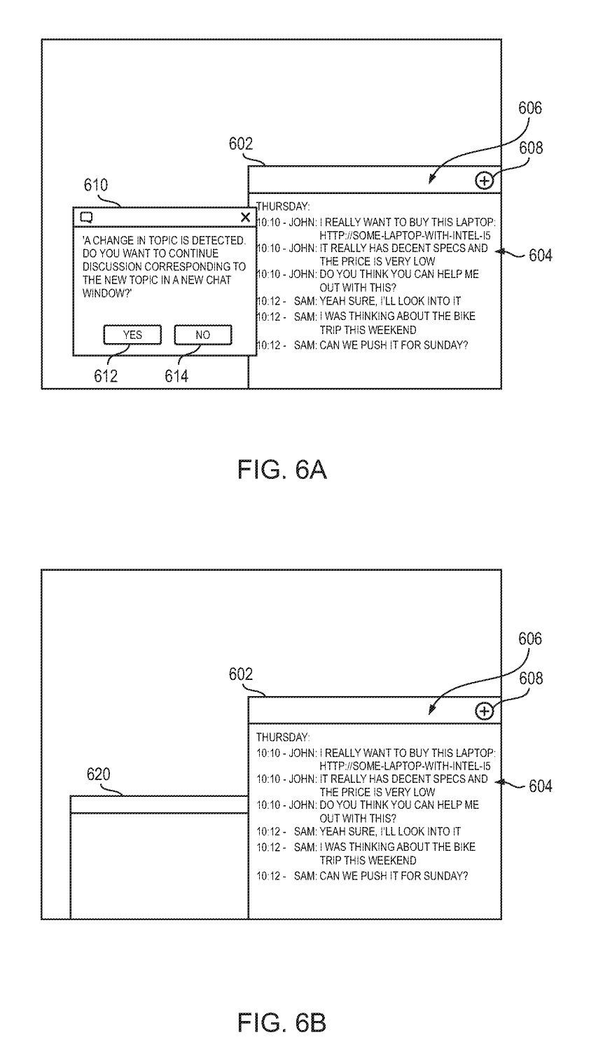

In at least one example embodiment, the system 150 may be caused to provide a suggestion to a user to continue discussion of a new topic in a new window for each new topic detected within a chat conversation. If a user provides an input indicating a user confirmation of the suggestion, then the system 150 may be caused to display a new chat window, such as the second chat window 410 shown in FIG. 4B. In at least some embodiments, the user may provide a title to the newly created chat window as explained with reference to FIG. 4B. An example provisioning of a suggestion to a user for discussing a new topic in a new chat window is explained with reference to FIGS. 6A and FIG. 6B.

FIG. 6A shows a simplified representation for illustrating a provisioning of a suggestion to a user for discussing a new topic in a new window, in accordance with an example embodiment of the invention. As explained with reference to FIG. 2, the system 150 may be configured to cause display of a first chat window, such as the first chat window 602, subsequent to access of the system 150 by the user (for example, via a local chat application program or a Web browser application). The first chat window 602 is configured to facilitate a chat conversation, such as the chat conversation 604 between the users John and Sam.

The first chat window 602 is further depicted to include a header portion 606. The header portion 606 is depicted to include a button 608 capable of receiving user input, such as a selection input. A user may provide a touch or a click input on the button 608 to provision the user selection. The user may provide such an input to indicate the user's requirement of initiating a new topic within the chat conversation 604. As explained with reference to FIGS. 2-4B, subsequent to reception of such a user input, the system 150 may be caused to display a second chat window.

In some embodiments, the system 150 may be configured to analyze chat messages exchanged between the users (such as users John and Sam) to detect if a new topic is initiated within the chat conversation. As explained above, a current context of the chat conversation may be learnt by analyzing current chat line, one or more succeeding chat lines and one or more preceding chat lines. Moreover, distance measures may be computed between words in the chat lines to detect a change in the context. If the distance between words in a chat line and words in one or more preceding chat lines is more than a predefined threshold value, then the change in context may be detected. If the change in context is detected, then in at least some embodiments, the system 150 may be caused to provide a suggestion to the user to continue discussion of the new topic in a new chat window. In FIG. 6A, a pop-up window 610 is displayed to the user for illustrating the provisioning of the suggestion to the user. The pop-up window 610 is depicted to include text ‘A change in topic is detected. Do you want to continue discussion corresponding to the new topic in a new chat window?’. The pop-up window 610 is further depicted to display buttons 612 and 614 including text ‘Yes’ and ‘No’, respectively. The user may provide a touch or a click input on the button 612 to provide a confirmation for the suggestion to discuss the new topic in a new chat window. In an embodiment, upon receiving such a user confirmation, the system 150 may be caused to display a new chat window, such as the second chat window 620 as exemplarily depicted in FIG. 6B. More specifically, FIG. 6B shows a simplified representation for illustrating display of a new chat window, i.e. chat window 620, in response to the user confirmation on the suggestion to continue discussion of the new topic in the new chat window. It is noted that in some embodiments, the first chat window 602 may preclude the button 608 and new chat windows, such as the chat window 620, may be created in response to topic changes detected in the chat conversation 604 by the system 150. Moreover, in some embodiments, the new chat window 620 may not be directly displayed upon receiving the user confirmation of the suggestion by selection of the ‘Yes’ button (i.e. button 612 in the pop-up window 610), but the user may have to subsequently select the button 608 in the first chat window to cause display of the new chat window 620.

Referring now to FIG. 2, in at least some embodiments, the system 150 is configured to provide the user with an option to move or copy one or more messages from the first chat window to the second chat window. More specifically, the user may be provided with an option to move messages (or copy and paste them) to a newly created chat window. The option may be provided to the user subsequent to the display of the newly created chat window. For example, the user may provide a right-click input or a touch input on a message to cause display of options for moving a message, copying a message or deleting a message. The user may then select the move (or copy) option to cause movement of the message to the new chat window. In some example scenarios, the user may not have anticipated a detailed discussion on a topic and accordingly may not have initiated a new thread. An option to move messages enables the user to organize chat content by topic even though he/she may have not created a separate thread at the time of initiation of the topic.

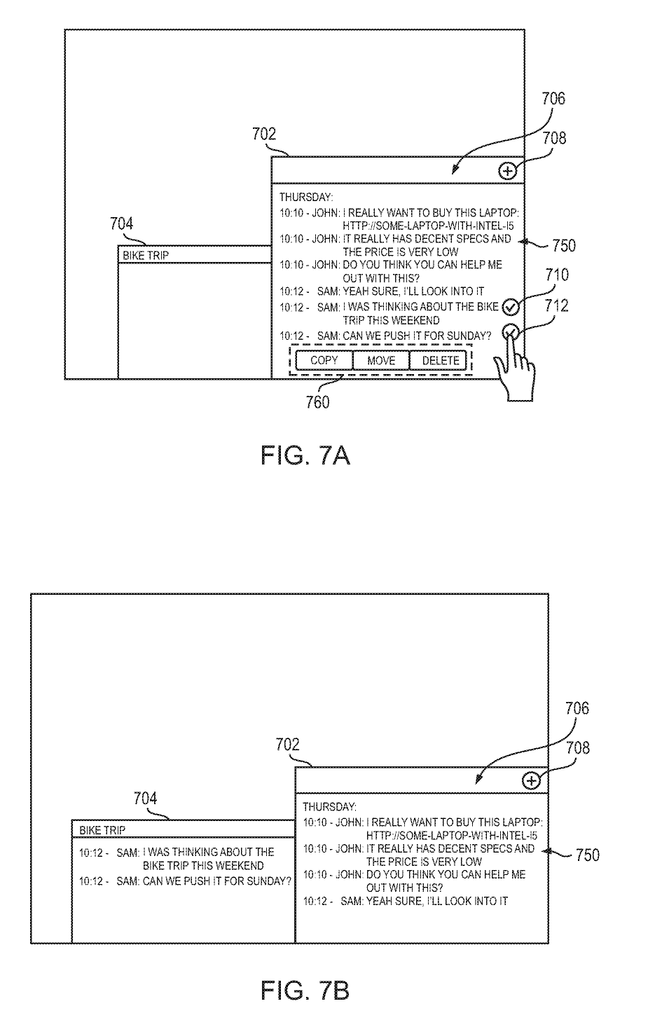

As explained above, the system 150 enables creation of a new chat window every time the user wants to initiate a new topic. Furthermore, the chat application also enables the user to move or copy messages to the newly created window. In such scenarios, the newly created chat window is initially empty and the UI is then populated with new chat conversation messages or in some cases by copying or movement of previous messages. An example provisioning of an option and the subsequent movement of the messages is further explained with reference to FIGS. 7A and 7B.

FIG. 7A shows a simplified representation of a first chat window 702 and a second chat window 704 displayed to a user for illustrating movement of messages from the first chat window 702 to the second chat window 704, in accordance with an example embodiment of the invention. As explained with reference to FIG. 2, the system 150 may be configured to cause display of a first chat window, such as the first chat window 702, subsequent to access of the system 150 by the user (for example, via a local chat application program or a Web browser application). The first chat window 702 is configured to facilitate a chat conversation, such as the chat conversation 750 between the user and one or more other users. The first chat window 702 is further depicted to include a header portion 706. The header portion 706 is depicted to include a button 708 capable of receiving user input, such as a selection input. A user may provide a touch or a click input on the button 708 to provision the user selection. The user may provide such an input to indicate the user's requirement of initiating a new topic within the chat conversation 750. As explained with reference to FIGS. 2-5, subsequent to reception of such a user input, the system 150 may be caused to display a second chat window, such as the second chat window 704. It is noted that the user may also be prompted to continue discussion of a new topic in a new chat window as explained with reference to FIGS. 6A and 6B.

The second chat window 704 is depicted to be empty initially. In an example scenario, the user may wish to move or copy one or more messages from the first chat window 702 to the second chat window 704. For example, the user may not have anticipated a detailed discussion on a topic and accordingly may have not initiated a new thread. The user may decide to start a new thread in a new window and accordingly may wish to move or copy one or more messages from the first chat window 702 to the newly created second chat window 704.

In an example scenario, the system 150 may provide an option to the user to provide a prolonged touch input (for example, a two-three second duration touch input) on a message to cause selection of the message. The user may select one or more messages as shown by the selected sign, exemplarily shown as tick marks 710 and 712 in FIG. 7A. The selection of the one or more messages may also cause display of an option tray, such as an option tray 760 including options ‘COPY’, ‘MOVE’ and ‘DELETE’. The user may choose the ‘COPY’ or ‘MOVE’ option from among the options in the option tray 760 to initiate copying or movement of the messages to the newly created second chat window 704. In an example embodiment, if there is only one additional chat window, such as the second chat window 704, then the selection of the ‘COPY’ or the ‘MOVE’ option may directly cause the movement of the selected messages. However, if there are multiple threads in multiple windows (such a scenario is depicted in FIG. 5), then the selection of an option may cause display of a pop-up with an option to select recipient chat window based on their respective titles. In an example scenario, the user may select the ‘MOVE’ option in the option tray 760 and the selected messages are then moved to the second chat window 704 as exemplarily depicted in FIG. 7B. More specifically, FIG. 7B depicts the second chat window 704 including the messages moved from the first chat window 702, in accordance with an example embodiment of the invention. It is noted that the user may also choose to copy the selected messages by using the ‘COPY’ option in the option tray 760 to retain a copy of the selected messages in the first chat window 702. The ‘DELETE’ option in the option tray 760 may be used to delete the selected messages. Such a scenario may occur, for instance, when the user copied or moved the selected messages to an incorrect chat window.

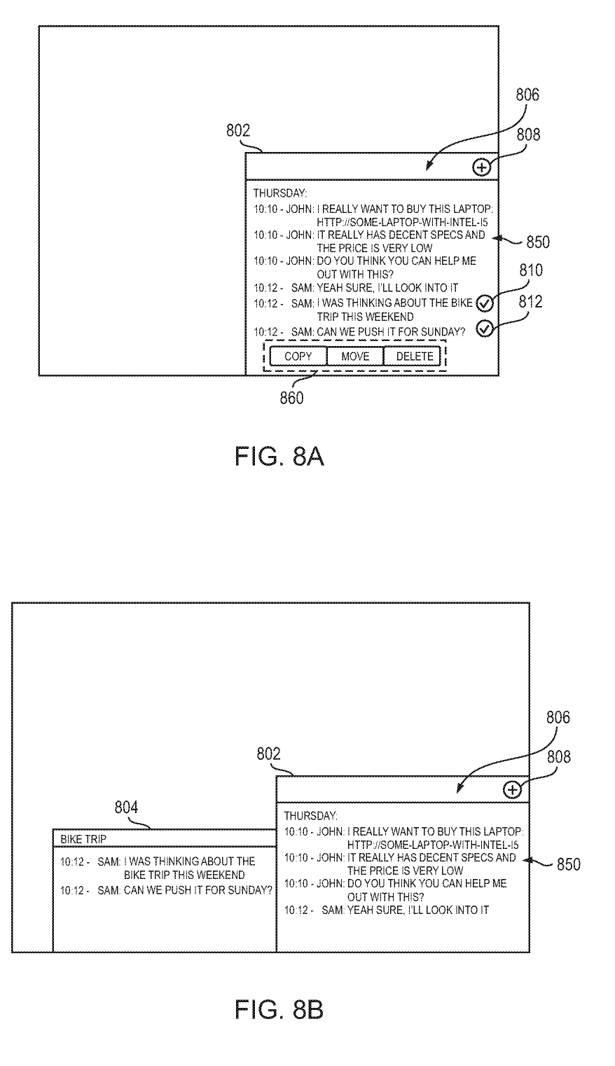

In the example scenario illustrated in FIGS. 7A and 7B, the user may move or copy one or more messages subsequent to the display of the newly created chat window. However, in some embodiments, the system 150 may also enable the newly created chat window to include some of the previous messages (for example, one or more chat lines) from the chat conversation preceding the display of the new chat window. To that effect, in at least some embodiments, the system 150 is configured to provide the user with an option to include one or more messages from the first chat window in the second chat window. Such an option may be provided to the user prior to causing display of the second chat window. The second chat window may then be configured to include the one or more messages when displayed. In an illustrative scenario, upon receiving the user input indicative of the user's desire to open a new chat window, the system 150 may be configured to display an icon next to each recent message in the chat window. The icon may be capable of being selected (for example, by a click input or a touch input) to indicate selection of the corresponding message. The user may then be asked whether the user wants to move the selected one or more messages to the new chat window. Upon receiving user confirmation, the new chat window including the selected messages may be displayed to the user. In such a scenario, the newly created chat window may open up with the selected messages. It is noted that in some embodiments, the user may not select any icon corresponding to the recent messages, in which case, the new chat window may be opened without including any previous chat conversation content. Such a scenario was explained with reference to FIG. 6B. Once the new chat window is opened, with or without content corresponding to the selected messages, the user may be provided with an option to provide a name/title to the chat window. Thereafter the user may proceed with the conversation related to a new topic in the new chat window. The display of the newly created chat window with selected messages is explained with reference to FIGS. 8A and 8B.

FIG. 8A shows a simplified representation of a first chat window 802 including an example chat conversation 850 displayed to a user, in accordance with an example embodiment of the invention. As explained with reference to FIG. 2, the system 150 may be configured to cause display of a first chat window, such as the first chat window 802, subsequent to access of the system 150 by the user (for example, via a local chat application program or a Web browser application). The first chat window 802 is configured to facilitate a chat conversation, such as the chat conversation 850 between the user and one or more other users. The first chat window 802 is further depicted to include a header portion 806. The header portion 806 is depicted to include a button 808 capable of receiving user input, such as a selection input. A user may provide a touch or a click input on the button 808 to provision the user selection. The user may provide such an input to indicate the user's requirement of initiating a new topic within the chat conversation 850. As explained with reference to FIGS. 2-5, subsequent to reception of such a user input, the system 150 may be caused to display a second chat window. It is noted that the user may also be prompted to continue discussion of a new topic in a new chat window as explained with reference to FIGS. 6A and 6B.

In an embodiment, subsequent to the reception of the user input, an icon may be displayed to one or more recent chat messages, such as the icons 810 and 812. It is noted that two messages are to be depicted to be selected by the system 150 for illustration purposes. In some embodiments, number of messages selected may be predefined in the system 150 or alternatively, machine-learning algorithms may be employed to interpret messages and suggest which messages could be moved or copied to the new chat window. Further an option tray, such as the option tray 860 including options ‘COPY’, ‘MOVE’ and ‘DELETE’ may be displayed to the user. As can be seen, the icons 810 and 812 and the option tray 860 are depicted to be displayed prior to the display of the new chat window. The user may choose to move or copy the selected messages or unselect the selection of messages by providing a touch input on the icons 810 and 812. Alternatively, the user may choose to select more messages or different messages than those preselected by the system 150. If the user chooses to move or copy the selected messages, the newly created chat window may be displayed to the user along with the selected messages. Such a scenario is depicted in FIG. 8B. More specifically, FIG. 8B shows the second chat window 804 including the selected messages when displayed to the user, in accordance with an example embodiment of the invention. It is noted that when multiple new threads are created in separate windows, the option to move or copy preselected messages from the first chat window 802 may similarly be provided to the user. Alternatively, the user may select and move/copy messages from different chat windows as explained with reference to FIGS. 7A and 7B. It is also noted that the movement or copying of messages is not restricted to the time of creation of a new window. A user may organize chat content into separate windows even at a later point in time. Moreover, the organization of chat content into multiple windows may be reflected to the other chat participant as well, or in some cases, the other chat participant may see a single view of the entire chat conversation without the topic-based segregation of chat content into multiple chat windows. Alternatively, each chat participant may view chat content as organized by him or her.

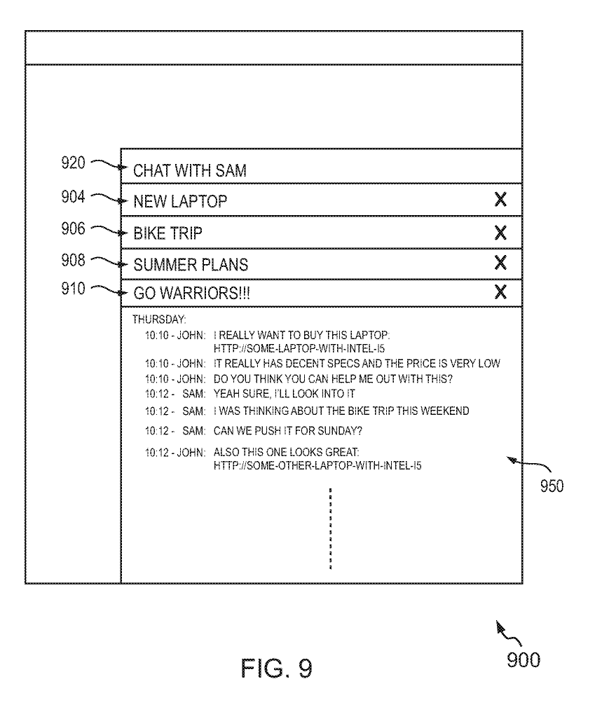

Splitting or separating the topics of a chat conversation in separate chat windows enables efficient organization of chat content, and the user may access the desired topic quickly without having to manually sift through the entire chat history. In at least one example embodiment, subsequent to the completion of the chat conversation all the chat windows may be collapsed and displayed in a cascaded form to the user as shown in FIG. 9.

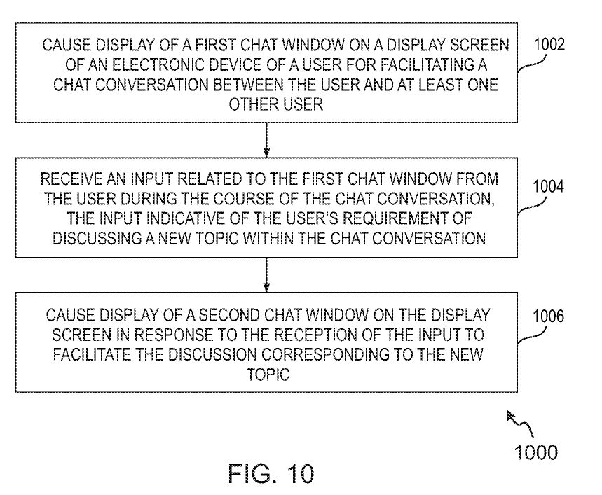

FIG. 9 shows an example representation 900 illustrating the plurality of chat windows in a collapsed form, in accordance with an example embodiment of the invention. In an embodiment, all the chat windows corresponding to the multiple topics discussed during the course of the chat conversation may be collapsed upon receiving a predefined user input, such as a touch or a click input on a minimize button (not shown in FIG. 9) and displayed in a cascaded form. Such a representation is depicted in FIG. 9. More specifically, only the header portions of each of the chat windows 904, 906, 908 and 910 may be displayed to the user. Moreover, the entire conversation in free-flowing or unorganized form may also be displayed in a master view as depicted by the portion 950 of the chat window 920. Further, the user may also choose to close one or more individual threads (with or without deleting the respective messages) by selecting the cross (i.e. ‘x’) icons shown in the header portions of the corresponding chat windows. As explained above, such organization of the chat content enables the user to quickly access desired information from the chat conversation. Moreover, the user may be able to keep track of topics and never fail to respond to any topic on account of high chat activity between the users. A method for organizing content of a chat conversation is explained next with reference to FIG. 10.

FIG. 10 is a flow diagram of a method 1000 for facilitating organization of content associated with a chat conversation, in accordance with an example embodiment of the invention. The various steps and/or operations of the flow diagram, and combinations of steps/operations in the flow diagram, may be implemented by, for example, hardware, firmware, a processor, circuitry and/or by the system 150 of FIG. 2 and/or by a different electronic device associated with the execution of software that includes one or more computer program instructions. The method 1000 starts at operation 1002.

At operation 1002, display of a first chat window is caused on a display screen of an electronic device of a user for facilitating a chat conversation between the user and at least one other user. As explained with reference to FIG. 1, a user may access the system 150 via a Web browser application or receive a chat application program from the system 150. The subsequent access of the downloaded chat application program may cause display of the first chat window. The first chat window may be configured to display a UI, such as the UI 350 explained with reference to FIG. 3, to facilitate a chat conversation with one or more other users.

At operation 1004, an input related to the first chat window is received from the user during the course of the chat conversation. The input is indicative of the user's requirement of discussing a new topic within the chat conversation. As explained with reference to the FIGS. 4A and 4B, the first chat window may be configured to enable the user to provision an input that is indicative of the user's desire to start a new topic. For example, the user may provide the input by selecting a button, such as the button 408 (shown in FIG. 4A), displayed in the header section of the first chat window. Alternatively, the user may provide a touch or a swipe input on the header section to provide the user selection.

At operation 1006, display of a second chat window is caused on the display screen in response to the reception of the input to facilitate the discussion corresponding to the new topic. As depicted in FIG. 4B and FIG. 5, a new chat window may be opened for each new topic that the user wishes to discuss. Subsequent to the display of a new chat window, the user may discuss the new topic with the same user in the new chat window. Accordingly, each new topic discussed during the course of the chat conversation may be discussed in a new chat window, thereby enabling organization of the chat content, while precluding manual effort on part of the user. The users may also move or copy messages from one chat window to another as explained with reference to FIGS. 7A, 7B, 8A and 8B. The chat windows may be collapsed and their respective headers may be displayed in a cascaded form as exemplarily depicted in FIG. 9. The method 1000 ends at 1006.

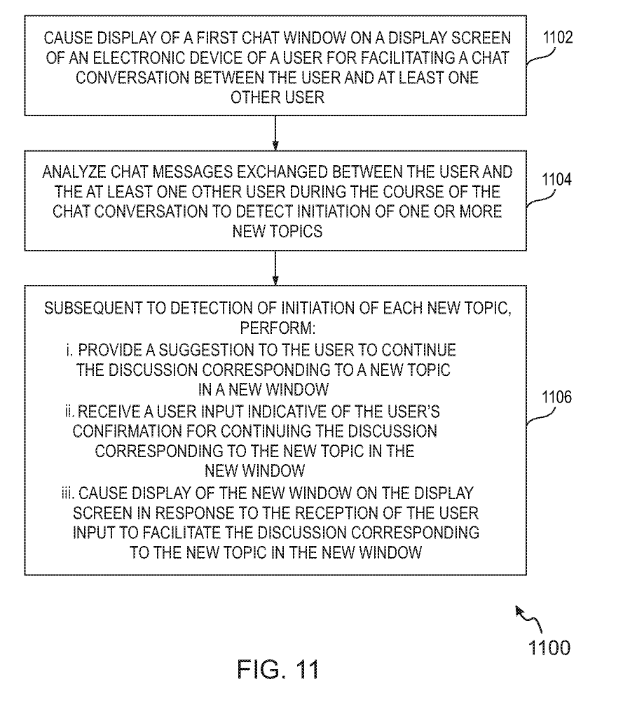

FIG. 11 is a flow diagram of a method 1100 for facilitating organization of content associated with a chat conversation, in accordance with another example embodiment of the invention. The various steps and/or operations of the flow diagram, and combinations of steps/operations in the flow diagram, may be implemented by, for example, hardware, firmware, a processor, circuitry and/or by the system 150 of FIG. 2 and/or by a different electronic device associated with the execution of software that includes one or more computer program instructions. In some embodiments, various steps and/or operations of the method 1100 may be implemented using decentralized protocol, wherein user devices (such as the user devices 104a-d shown in FIG. 1) are configured to perform the functionalities explained herein with reference to the system 150, while precluding the need to have a centralized system such as the system 150 to facilitate organization of content associated with chat conversations. It is noted that, in such a scenario, a remote database or a cloud based system may be utilized for storing the chat content and/or for provisioning the logic for machine learning based on analysis of the stored chat content. The method 1100 starts at operation 1102.

At operation 1102, display of a first chat window on a display screen of an electronic device of a user is caused for facilitating a chat conversation between the user and at least one other user. The display of the first chat window may be caused as explained with reference to operation 1002 of FIG. 10 and is not explained herein.

At operation 1104, chat messages exchanged between the user and the at least one other user during the course of the chat conversation are analyzed to detect initiation of one or more new topics. As explained above, a current context of the chat conversation may be learnt by analyzing current chat line, one or more succeeding chat lines and one or more preceding chat lines. Moreover, distance measures may be computed between words in the chat lines to detect a change in the context. If the distance between words in a chat line and words in one or more preceding chat lines is more than a predefined threshold value, then the change in context may be detected, or in other words, an initiation of a new topic may be detected.

At operation 1106, subsequent to detection of initiation of each new topic, a suggestion to the user to continue the discussion corresponding to a new topic in a new window is provided. The provisioning of the suggestion is exemplarily depicted using a pop-up window 610 in FIG. 6A.

A user input indicative of the user's confirmation for continuing the discussion corresponding to the new topic in the new window is received. For example, the user may provide a confirmation of the suggestion by clicking on the ‘Yes’ button (i.e. button 612) in the pop-up window 610 or selecting a button like the button 408 on the first chat window 402 shown in FIG. 4A. A display of the new window may then be caused on the display screen in response to the reception of the user input to facilitate the discussion corresponding to the new topic in the new window. The display of new chat window may be caused as explained with reference to FIG. 6B and is not explained again herein. Further, in at least one example embodiment, the user may be provided an option to select a title for each new topic. The title may then be displayed on the respective new window as depicted in FIG. 5.

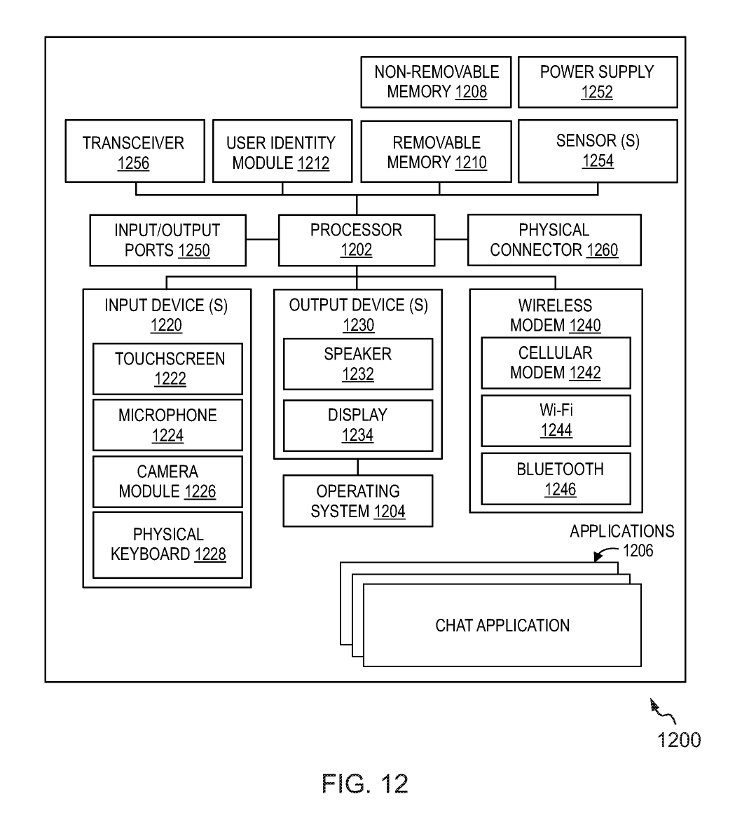

FIG. 12 illustrates an electronic device 1200 capable of implementing the various embodiments of the present invention. In an embodiment, the various operations performed by the system 150 may be implemented using an application in an electronic device, such as the electronic device 1200. For example, the electronic device 1200 may correspond to a device associated with a chat participant or in general with any user of the chat application. The electronic device 1200 is depicted to include one or more applications 1206, including a chat application, which serves as an instance of the application downloaded from the system 150 and which is capable of communicating through API calls with the system 150 to facilitate organization of chat content of conversations conducted using the electronic device 1200.

It should be understood that the electronic device 1200 as illustrated and hereinafter described is merely illustrative of one type of device and should not be taken to limit the scope of the embodiments. As such, it should be appreciated that at least some of the components described below in connection with that the electronic device 1200 may be optional and thus in an example embodiment may include more, less or different components than those described in connection with the example embodiment of the FIG. 12. As such, among other examples, the electronic device 1200 could be any of electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1200 includes a controller or a processor 1202 (e.g., a signal processor, microprocessor, ASIC, or other control and processing logic circuitry) for performing such tasks as signal coding, data processing, image processing, input/output processing, power control, and/or other functions. An operating system 1204 controls the allocation and usage of the components of the electronic device 1200 and support for one or more applications programs (see, applications 1206), such as the chat application, that implements one or more of the innovative features described herein. In addition to the chat application, the applications 1206 may include common mobile computing applications (e.g., telephony applications, email applications, calendars, contact managers, web browsers, messaging applications) or any other computing application. The chat application, in at least one example embodiment, may be configured to provide the logic to facilitate organization of chat content, as explained with reference to FIGS. 1 to 11. More specifically, the chat application may cause the electronic device 1200 to display the first chat window on the display screen (for example, touch screen 1222) upon user access of the chat application; to receive input related to the first chat window, where the input is indicative of the user's requirement to discuss a new topic; and to display a second chat window on the display screen in response to the received input.

The illustrated electronic device 1200 includes one or more memory components, for example, a non-removable memory 1208 and/or removable memory 1210. The non-removable memory 1208 can include RAM, ROM, flash memory, a hard disk, or other well-known memory storage technologies. The removable memory 1210 can include flash memory, smart cards, or a Subscriber Identity Module (SIM). The one or more memory components can be used for storing data and/or code for running the operating system 1204 and the applications 1206. The electronic device 1200 may further include a user identity module (UIM) 1212. The UIM 1212 may be a memory device having a processor built in. The UIM 1212 may include, for example, a subscriber identity module (SIM), a universal integrated circuit card (UICC), a universal subscriber identity module (USIM), a removable user identity module (R-UIM), or any other smart card. The UIM 1212 typically stores information elements related to a mobile subscriber. The UIM 1212 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1200 can support one or more input devices 1220 and one or more output devices 1230. Examples of the input devices 1220 may include, but are not limited to, a touch screen 1222 (e.g., capable of capturing finger tap inputs, finger gesture inputs, multi-finger tap inputs, multi-finger gesture inputs, or keystroke inputs from a virtual keyboard or keypad), a microphone 1224 (e.g., capable of capturing voice input), a camera module 1226 (e.g., capable of capturing still picture images and/or video images) and a physical keyboard 1228. Examples of the output devices 1230 may include, but are not limited to a speaker 1232 and a display 1234. Other possible output devices (not shown in the FIG. 12) can include piezoelectric or other haptic output devices. Some devices can serve more than one input/output function. For example, the touch screen 1222 and the display 1234 can be combined into a single input/output device.

A wireless modem 1240 can be coupled to one or more antennas (not shown in the FIG. 12) and can support two-way communications between the processor 1202 and external devices, as is well understood in the art. The wireless modem 1240 is shown generically and can include, for example, a cellular modem 1242 for communicating at long range with the mobile communication network, a Wi-Fi compatible modem 1244 for communicating at short range with an external Bluetooth-equipped device or a local wireless data network or router, and/or a Bluetooth-compatible modem 1246. The wireless modem 1240 is typically configured for communication with one or more cellular networks, such as a GSM network for data and voice communications within a single cellular network, between cellular networks, or between the electronic device 1200 and a public switched telephone network (PSTN).

The electronic device 1200 can further include one or more input/output ports 1250, a power supply 1252, one or more sensors 1254 for example, an accelerometer, a gyroscope, a compass, or an infrared proximity sensor for detecting the orientation or motion of the electronic device 1200, a transceiver 1256 (for wirelessly transmitting analog or digital signals) and/or a physical connector 1260, which can be a USB port, IEEE 1294 (FireWire) port, and/or RS-232 port. The illustrated components are not required or all-inclusive, as any of the components shown can be deleted and other components can be added.

Without in any way limiting the scope, interpretation, or application of the claims appearing below, a technical effect of one or more of the example embodiments disclosed herein is to enable users to organize content of chat conversations. More specifically, various techniques disclosed herein enable the user to initiate several new topic threads in separate chat windows. When the user accesses the chat conversation with the user at a later point in time, the various chat windows may be displayed within a single chat window in a cascaded form and the user may choose any window to view the chat history related to the topic discussed in that chat window. In some embodiments, the chat application also enables users to move messages (or copy and paste them) to a newly created chat window at a later point in time. Moreover, in some embodiments, the newly opened chat windows may also be configured to include one or more recent chat conversation lines, as selected by the user. Such organization of chat content enables the user to quickly retrieve the desired information from chat content. Moreover, the user may never fail to respond to any topic on account of high chat activity, as the topics are not mixed with each other as in conventional chats.

Although the invention has been described with reference to specific exemplary embodiments, it is noted that various modifications and changes may be made to these embodiments without departing from the broad spirit and scope of the invention. For example, the various operations, modules, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 150 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 10 and 11). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those, which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
causing display of a first chat window on a display screen of an electronic device of a user for facilitating a chat conversation between the user and at least one other user;
receiving input related to the first chat window from the user during the course of the chat conversation, the input indicative of the user's requirement of discussing a new topic within the chat conversation; and
causing display of a second chat window on the display screen in response to the reception of the input to facilitate the discussion corresponding to the new topic.

2. The method as claimed in claim 1, wherein the first chat window is configured to display one of a button, a tab and a widget, and wherein the input related to the first chat window comprises selection of one of the button, the tab and the widget.

3. The method as claimed in claim 1, wherein the input related to the first chat window is provided by the user using a predefined gesture.

4. The method as claimed in claim 1, further comprising:
providing an option to the user to select a title for the new topic, wherein the title is capable of being displayed on the second chat window.

5. The method as claimed in claim 1, further comprising:
providing the user with an option to include one or more messages from the first chat window in the second chat window, the option provided to the user prior to causing the display of the second chat window, wherein the second chat window is configured to include the one or more messages when displayed if the option to include the one or more messages is selected by the user.

6. The method as claimed in claim 1, further comprising:
providing the user with an option to move or copy one or more messages from the first chat window to the second chat window, the option provided to the user subsequent to the display of the second chat window.

7. The method as claimed in claim 1, further comprising:
causing display of one or more additional chat windows subsequent to the display of the second chat window, the display of each additional chat window from among the one or more additional chat windows caused in response to the reception of a corresponding input related to the first chat window from the user, wherein each additional chat window is associated with a respective title provided by the user as an identification of a corresponding topic

8. The method as claimed in claim 7, wherein the second chat window and the one or more additional chat windows are configured to collapse in a cascaded form within the first chat window upon receiving a predefined user input, and wherein the second chat window and the one or more additional chat windows are configured to display respective titles in the cascaded form.

9. The method as claimed in claim 1, further comprising:
analyzing chat messages exchanged between the user and the at least one other user in the first chat window, wherein the chat messages are analyzed to detect initiation of the new topic; and
providing a suggestion to the user to continue the discussion corresponding to the new topic in a new window if the initiation of the new topic is detected, wherein the input related to the first chat window is provisioned by the user in response to the suggestion.

10. The method as claimed in claim 9, further comprising performing analysis of subsequent chat messages of the chat conversation to detect initiation of newer topics and providing suggestion to continue discussion of each new topic in a respective separate window to facilitate topic-based segregation of the chat conversation into multiple windows.

11. A system for facilitating organization of content associated with chat conversations, the system comprising:
at least one processor; and
a memory having stored therein machine executable instructions, that when executed by the at least one processor, cause the system to:
cause display of a first chat window on a display screen of an electronic device of a user for facilitating a chat conversation between the user and at least one other user;
receive input related to the first chat window from the user during the course of the chat conversation, the input indicative of the user's requirement of discussing a new topic within the chat conversation; and
cause display of a second chat window on the display screen in response to the reception of the input to facilitate the discussion corresponding to the new topic.

12. The system as claimed in claim 11, wherein the first chat window is configured to display one of a button, a tab and a widget, and wherein the input related to the first chat window comprises selection of one of the button, the tab and the widget.

13. The system as claimed in claim 11, wherein the system is further caused to:
provide an option to the user to select a title for the new topic, wherein the title is capable of being displayed on the second chat window.

14. The system as claimed in claim 11, wherein the system is further caused to perform at least one of:
provide the user with an option to include one or more messages from the first chat window in the second chat window, the option provided to the user prior to causing the display of the second chat window, wherein the second chat window is configured to include the one or more messages when displayed if the option to include the one or more messages is selected by the user; and
provide the user with an option to move or copy one or more messages from the first chat window to the second chat window, the option provided to the user subsequent to the display of the second chat window.

15. The system as claimed in claim 11, wherein the system is further caused to:
cause display of one or more additional chat windows subsequent to the display of the second chat window, the display of each additional chat window from among the one or more additional chat windows caused in response to the reception of a corresponding input related to the first chat window, and wherein each additional chat window is associated with a respective title provided by the user as an identification of a corresponding topic.

16. The system as claimed in claim 15, wherein the second chat window and the one or more additional chat windows are configured to collapse in a cascaded form within the first chat window upon receiving a predefined user input, and wherein the second chat window and the one or more additional chat windows are configured to display respective titles in the cascaded form.

17. The system as claimed in claim 11, wherein the system is further caused to:
analyze chat messages exchanged between the user and the at least one other user in the first chat window, wherein the chat messages are analyzed to detect initiation of the new topic; and
provide a suggestion to the user to continue the discussion corresponding to the new topic in a new window if the initiation of the new topic is detected, wherein the input related to the first chat window is provisioned by the user in response to the suggestion.

18. The system as claimed in claim 17, wherein the system is further caused to perform analysis of subsequent chat messages of the chat conversation to detect initiation of newer topics and provide suggestion to continue discussion of each new topic in a respective separate window to facilitate topic-based segregation of the chat conversation into multiple windows.

19. A computer-implemented method, comprising:
causing display of a first chat window on a display screen of an electronic device of a user for facilitating a chat conversation between the user and at least one other user;
analyzing chat messages exchanged between the user and the at least one other user during the course of the chat conversation, wherein the chat messages are analyzed to detect initiation of one or more new topics; and
subsequent to detection of initiation of each new topic, performing:
providing a suggestion to the user to continue the discussion corresponding to a new topic in a new window,
receiving user input indicative of the user's confirmation for continuing the discussion corresponding to the new topic in the new window, and
causing display of the new window on the display screen in response to the reception of the user input to facilitate the discussion corresponding to the new topic in the new window.

20. The method as claimed in claim 19, further comprising:
providing an option to the user to select a title for each new topic, wherein the title is capable of being displayed on the respective new window.
